(19) United States
(12) Patent Application Publication
(10) Pub. No.: US 2019/0134934 A1
(43) Pub. Date: May 9, 2019

(54) SYSTEM AND METHOD FOR FORMING A FOLD LINE IN A SUBSTRATE

(71) Applicant: HIGHCON SYSTEMS LTD., Yavne (IL)

(72) Inventors: Ron Or, Tel Aviv (IL); Claudio ROTTMAN, Modiin (IL); Michael ZIMMER, Beit Elazari (IL)

(21) Appl. No.: 16/304,289

(22) PCT Filed: May 30, 2017
(86) PCT No.: PCT/IB2017/053157

§ 371 Date: Nov. 25, 2018

Related U.S. Application Data
(60) Provisional application No. 62/343,060, filed on May 30, 2016.

(51) Int. Cl. B31B 50/26; B26D 7/00; B26D 5/00; B26F 3/00; B31B 50/00; B65D 5/00; B26D 3/08

(52) U.S. Cl. CPC B31B 50/262; B26D 7/00; B26D 5/00; B26D 3/08; B31B 50/003; B65D 5/0015; B26F 3/004

(57) ABSTRACT

A system and a method for creating a fold line in a substrate, by impressing at least one crease line onto the substrate. The impressing is carried out by compressing the substrate between a die and a corresponding counter die of a creasing module. Following impression of the crease line, at least one cut is made in the substrate along the crease line thereby to form the fold line. The at least one cut has a depth less than the thickness of the substrate at the crease line.

### FIELD OF THE INVENTION

The present invention relates to fold lines in a substrate, and, more particularly, to a fold line including at least one cut placed over a crease line in the substrate.

### SUMMARY OF THE INVENTION

According to one aspect of the present invention there is provided a system for creating a fold line in a substrate, the system including:

a creasing module including a die, a counter die, and a compression mechanism, the creasing module adapted to impress at least one crease line onto the substrate by compressing the substrate between the die and the counter die by means of the compression mechanism; and

a cutting module adapted to make at least one cut in the substrate, the at least one cut having a depth less than the thickness of the substrate at the crease line,

the crease line and the at least one cut being at least partially overlapping so as to form the fold line.

In some embodiments, the substrate is impacted by the creasing module prior to being impacted by the cutting module, and wherein the cutting module is adapted to make the at least one cut along the crease line.

In other embodiments, the substrate is impacted by the cutting module prior to being impacted by the creasing module, and wherein the creasing module is adapted to impress the crease line onto the substrate along the at least one cut.

In some embodiments, the die includes at least one rule and the counter die includes a counter film which is featureless in a region thereof opposing the at least one rule.

In some embodiments, the die includes at least one channel and the counter die includes a counter film which is featureless in a region thereof opposing the at least one channel.

In some embodiments, the die includes at least one rule and the counter die includes at least one channel corresponding in shape and positioning to the at least one rule.

In some embodiments, the cutting module includes at least one mechanical cutter. In some embodiments, the cutting module includes a laser module. In some embodiments, the cutting module includes a jet stream cutter.

In some embodiments, the system further includes an input module adapted to align the substrate in a desired orientation and to feed the aligned substrate to the creasing module and a conveyance mechanism adapted to convey the substrate to the creasing module while the substrate remains in the desired orientation.

In some embodiments, the creasing module forms part of a creasing station, and the cutting module forms part of a cutting station, and the conveyance mechanism is adapted to convey the substrate from the creasing station to the cutting station while the substrate remains in the desired orientation.

In some embodiments, the system further includes an output module adapted to receive the substrate following cutting thereof by the cutting module, wherein the conveyance mechanism is further adapted to convey the substrate from the cutting module to the output module. In some embodiments, the substrate includes multiple sheets of the substrate, wherein the multiple sheets are stacked in the desired orientation at the input module, and wherein the conveyance mechanism is adapted to convey each of the sheets of the substrate, in the desired orientation, from the input module to the creasing module for impressing the at least one crease line thereonto and to convey each of the multiple sheets of the substrate, following cutting thereof, from the cutting module to the output module to be stacked thereon.

In some embodiments, wherein a total length of the at least one cut is less than a length of the crease line. In some embodiments, a total length of the at least one cut is at most 75%, at most 60%, at most 50%, or at most 40% of a length of the crease line.

In some embodiments, the at least one cut includes a single cut disposed at a center of the crease line. In some embodiments, the at least one cut includes two cuts disposed at edges of the crease line and having a non-cut area therebetween. In some embodiments, the at least one cut includes a plurality of cuts regularly spaced along the crease line.

In some embodiments, the depth of the at least one cut is at least 5%, at least 10%, or at least 15% of the thickness of the substrate at the crease line. In some embodiments, the depth of the at least one cut is at most 70%, at most 60%, at most 50%, at most 40%, at most 30%, or at most 25% of the thickness of the substrate at the crease line.

In some embodiments, the depth of the at least one cut is in the range of 5%-70%, 5%-60%, 5%-50%, 5%-40%, 7%-40%, 10%-40%, 12%-40%, 15%-40%, 10%-35%, 12%-35%, 15%-35%, 10%-30%, 12%-30%, 15%-30%, or 15%-25% of the thickness of the substrate at the crease line.

In some embodiments, a folding force of the fold line is in the range of 30%-65%, 30%-60%, 35%-60%, 40%-60%, 45%-60%, or 45%-55% of a folding force of the crease line prior to cutting thereof.

In some embodiments, a variation of the depth of the at least one cut along the at least one cut is within 15%, within 10%, within 8%, or within 5% of the thickness of the substrate.

In some embodiments, a variation of the depth of the at least one cut along the at least one cut is within 15%, within 10%, within 8%, or within 5% of the depth of the at least one cut.

In some embodiments, the at least one cut is disposed at a center of a cross section of the crease line. In some embodiments, the at least one cut is disposed at a minimum point of a cross section of the crease line.

In some embodiments, in the fold line, a bead of the crease line is visible along an entire length of the fold line. In some embodiments, a bead of the crease line is visible in sections of the crease line including the at least one cut.

In some embodiments, the substrate includes a fibrous substrate. In some embodiments, the substrate includes cardboard. In some embodiments, the substrate includes a corrugated substrate. In some embodiments, the substrate has a thickness greater than 450 μm, greater than 500 μm, greater than 550 μm, greater than 600 μm, or greater than 650 μm. In some embodiments, the substrate is a laminated fibrous substrate. In some embodiments, the laminated fibrous substrate has a thickness less than 350 μm, less than 300 μm, less than 250 μm, or less than 200 μm.

According to another aspect of the present invention there is provided a method for creating a fold line in a substrate, the method including: impressing a crease line onto the substrate by compressing the substrate between a die and a corresponding counter die of a creasing module; and

making at least one cut in the substrate, the at least one cut having a depth less than the thickness of the substrate at the crease line,

wherein the crease line and the at least one cut at least partially overlap so as to form the fold line.

In some embodiments, impressing a crease line occurs prior to making at least one cut, and wherein making at least one cut includes making the at least one cut along the crease line.

In some embodiments, making the at least one cut occurs prior to impressing a crease line, and wherein impressing a crease line includes impressing the crease line along the at least one cut.

In some embodiments, making at least one cut includes cutting the substrate using a mechanical cutter. In some embodiments, making at least one cut includes cutting the substrate using a laser module. In some embodiments, making at least one cut includes cutting the substrate using a jet stream cutter.

In some embodiments, the method further includes aligning the substrate in a desired orientation, and using a conveyance mechanism, feeding the substrate to the creasing module in a desired orientation. In some embodiments, impressing is carried out at a creasing station and the making at least one cut is carried out at a cutting station, the method further including conveying the substrate from the creasing station to the cutting station while the substrate remains in the desired orientation.

In some embodiments, making at least one cut includes making at least one cut having a total length less than a length of the crease line. In some embodiments, a total length of the at least one cut is at most 75%, at most 60%, at most 50%, or at most 40% of a length of the crease line.

In some embodiments, making at least one cut includes making a single cut disposed at a center of the crease line. In some embodiments, making at least one cut includes making two cuts disposed at edges of the crease line and having a non-cut area therebetween. In some embodiments, making at least one cut includes making a plurality of cuts regularly spaced along the crease line.

In some embodiments, the depth of the at least one cut is at least 5%, at least 10%, or at least 15% of the thickness of the substrate at the crease line. In some embodiments, the depth of the at least one cut is at most 70%, at most 60%, at most 50%, at most 40%, at most 30%, or at most 25% of the thickness of the substrate at the crease line.

In some embodiments, depth of the at least one cut is in the range of 5%-70%, 5%-60%, 5%-50%, 5%-40%, 7%-40%, 10%-40%, 12%-40%, 15%-40%, 10%-35%, 12%-35%, 15%-35%, 10%-30%, 12%-30%, 15%-30%, or 15%-25% of the thickness of the substrate at the crease line.

In some embodiments, a folding force of the fold line is in the range of 30%-65%, 30%-60%, 35%-60%, 40%-60%, 45%-60%, or 45%-55% of a folding force of the crease line prior to cutting thereof.

In some embodiments, a variation of the depth of the at least one cut along the at least one cut is within 15%, within 10%, within 8%, or within 5% of the thickness of the substrate. In some embodiments, a variation of the depth of the at least one cut along the at least one cut is within 15%, within 10%, within 8%, or within 5% of the depth of the at least one cut.

In some embodiments, the at least one cut is disposed at a center of a cross section of the crease line. In some embodiments, the at least one cut is disposed at a minimum point of a cross section of the crease line.

In some embodiments, a bead of the crease line is visible along an entire length of the fold line. In some embodiments, a bead of the crease line is visible in sections of the crease line including the at least one cut.

In some embodiments, the substrate includes a fibrous substrate. In some embodiments, the substrate includes cardboard. In some embodiments, the substrate includes a corrugated substrate. In some embodiments, the substrate has a thickness greater than 450 μm, greater than 500 μm, greater than 550 μm, greater than 600 μm, or greater than 650 μm.

In some embodiments, the fibrous substrate is a laminated fibrous substrate. In some embodiments, the laminated fibrous substrate has a thickness less than 350 μm, less than 300 μm, less than 250 μm, or less than 200 μm.

According to yet another aspect of the present invention there is provided a method of forming a three dimensional folded product from a substrate sheet, the method including:

creating a plurality of fold lines in the substrate sheet according to the method described herein; and

folding the substrate sheet along the plurality of fold lines thereby to form the three dimensional folded product.

In some embodiments, the folded product includes a box, a folder, or a greeting card.

According to a further aspect of the present invention there is provided a three dimensional folded product including at least one substrate sheet folded along at least one fold line, at least one of at least one fold line including a crease line having at least one cut formed therealong, the at least one cut having a depth less than the thickness of the substrate sheet at the crease line.

In some embodiments, the folded product includes a box, a folder, or a greeting card.

In some embodiments, a total length of the at least one cut is less than a length of the crease line. In some embodiments, a total length of the at least one cut is at most 75%, at most 60%, at most 50%, or at most 40% of a length of the crease line.

In some embodiments, the at least one cut includes a single cut disposed at a center of the crease line. In some embodiments, the at least one cut includes two cuts disposed at edges of the crease line and having a non-cut area therebetween. In some embodiments, the at least one cut includes a plurality of cuts regularly spaced along the crease line.

In some embodiments, the depth of the at least one cut is at least 5%, at least 10%, or at least 15% of the thickness of the substrate at the crease line. In some embodiments, the depth of the at least one cut is at most 70%, at most 60%, at most 50%, at most 40%, at most 30%, or at most 25% of the thickness of the substrate at the crease line.

In some embodiments, the depth of the at least one cut is in the range of 5%-70%, 5%-60%, 5%-50%, 5%-40%, 7%-40%, 10%-40%, 12%-40%, 15%-40%, 10%-35%, 12%-35%, 15%-35%, 10%-30%, 12%-30%, 15%-30%, or 15%-25% of the thickness of the substrate at the crease line.

In some embodiments, a folding force of the fold line is in the range of 30%-65%, 30%-60%, 35%-60%, 40%-60%, 45%-60%, or 45%-55% of a folding force of the crease line prior to cutting thereof.

In some embodiments, a variation of the depth of the at least one cut along the at least one cut is within 15%, within 10%, within 8%, or within 5% of the thickness of the substrate. In some embodiments, a variation of the depth of the at least one cut along the at least one cut is within 15%, within 10%, within 8%, or within 5% of the depth of the at least one cut.

In some embodiments, the at least one cut is disposed at a center of a cross section of the crease line. In some embodiments, the at least one cut is disposed at a minimum point of a cross section of the crease line.

In some embodiments, a bead of the crease line is visible along an entire length of the fold line. In some embodiments, a bead of the crease line is visible in sections of the crease line including the at least one cut.

In some embodiments, the at least one substrate sheet includes a fibrous substrate sheet. In some embodiments, the at least one substrate sheet includes a cardboard sheet. In some embodiments, the at least one substrate sheet includes a corrugated substrate sheet. In some embodiments, the at least one substrate sheet has a thickness greater than 450 μm, greater than 500 μm, greater than 550 μm, greater than 600 μm, or greater than 650 μm.

In some embodiments, the fibrous substrate sheet is a laminated fibrous substrate sheet. In some embodiments, the laminated fibrous substrate sheet has a thickness less than 350 μm, less than 300 μm, less than 250 μm, or less than 200 μm.

According to a further aspect of the present invention there is provided a system for producing a blank having a fold line about which the blank is to be folded forming a finished product from the blank, which system includes a feeding station, a creasing station and a cutting station, the feeding station serving to supply sheets of a substrate in a desired orientation to the creasing station, the creasing station serving to deform the substrate in order to create the fold line by compressing the substrate between a die and a counter die, and the cutting station serving to make at least one cut in the substrate along the fold line, the or each cut having a depth less than the thickness of the substrate at the fold line.

In some embodiments, the total length of the cut or cuts is less than the length of the fold line.

In some embodiments, a plurality of regularly spaced cuts are formed in the substrate along the fold line.

According to another aspect of the present invention there is provided a method of producing a blank having a fold line about which the blank is to be folded forming a finished product from the blank, which method includes feeding a substrate sheet in a desired orientation between a male dies and a female die of creasing station to form the fold line, and making at least one cut in the substrate along the fold line, the or each cut having a depth less than the thickness of the substrate at the fold line.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a schematic block diagram of an embodiment of a system for forming a fold line on a substrate, according to an embodiment of the present invention;

FIGS. 2A and 2B are schematic cross-sectional diagrams of embodiments of a creasing module forming part of the system of FIG. 1 in accordance with aspects of the present invention;

FIG. 3 is a flow chart of a method for forming a fold line in a substrate and for forming a three dimensional folded product;

FIGS. 4A, 4B, 4C, 4D, and 4E are schematic examples of locations of cuts on a crease line in a fold line according to embodiments of the present invention;

FIGS. 5A and 5B are graphs illustrating the reduction in the folding force required to fold a substrate along the respective fold lines of FIGS. 4A and 4B; and

FIG. 6 is a graph representing the impact of the depth of a cut along the fold line of a substrate on the folding force required in order to fold the substrate along the fold line.

### DESCRIPTION OF THE PREFERRED EMBODIMENTS

The present invention relates to fold lines in a substrate, and, more particularly, to a fold line including at least one cut placed over a crease line in the substrate, which requires less force to fold than an un-cut crease line.

In the context of the present application and the claims herein, the term “substrate” relates to a workpiece having an impressionable substrate, which, following impression of a broad surface of the substrate by a die and counter-die system, under ambient and/or above-ambient conditions, the impression pattern, after disengagement from the die and counter-die system, is maintained or at least substantially maintained. The substrate must also be sufficiently thick so as to accommodate cuts which do not extend through the entire thickness of the substrate. Such substrates typically include fibrous paper substrates (including, but not limited to, boxboard, cardboard, folding carton, printed folding carton, coated folding carton, cardboard with a metalized coating, and laminated cardboard).

In the context of the present application and of the claims herein, the term “attached” relates to direct attachment between two objects, attachment between two objects via an adhesive layer, or attachment between two objects via one or more intermediate objects or layers.

In the context of the present application and of the claims herein, the term “machine direction” relates to the direction in which a substrate or a conveyor would move through points in a system, from the input of the system to the output of the system, via any intermediate stations, in typical use.

In the context of the present application and of the claims herein, the term “cross machine direction” relates to an axis of the system or machine that is perpendicular to the machine direction.

In the context of the present application and of the claims herein, the term “grain direction” of a substrate relates to a direction or axis of a fibrous substrate extending along the length of fibers in the fibrous substrate.

In the context of the present application and of the claims herein, the term “cross grain direction” of a substrate relates to a direction or axis of the fibrous substrate extending perpendicular to the length of the fibers, which consequently extends through multiple fibers. The cross grain direction is perpendicular to the grain direction.

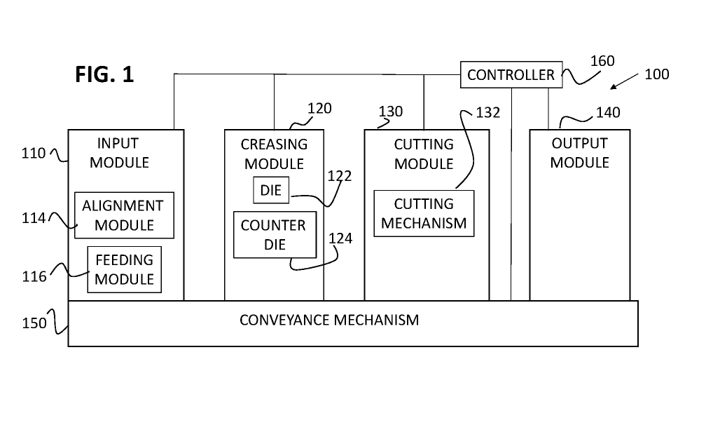

Reference is now made to FIG. 1, which is a schematic block diagram of an embodiment of a system for forming a fold line on a substrate according to an embodiment of the present invention.

As seen in FIG. 1, a system 100 includes an input module 110, which may include an alignment module 114 for aligning one or more substrates in a desired orientation, for example when the substrate enters the system or by taking the substrate from a suitable stack of substrates and a feeding module 116.

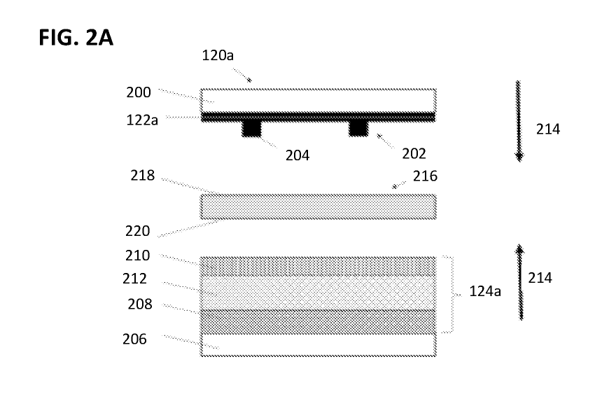

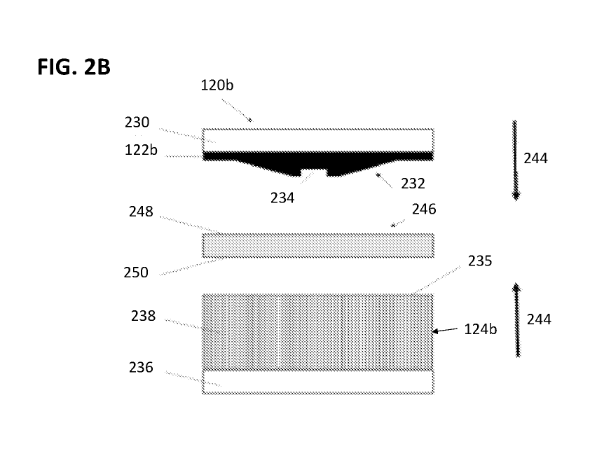

A creasing module 120 is disposed downstream of the input module 110. The creasing module 120 is adapted to impress at least one crease line onto the substrate, by compressing the substrate between a die 122 and a counter die 124. The creasing module may include any mechanism known in the art for applying a crease line to a substrate, such as a rule male die and a correspondingly shaped female counter die, adapted to be pushed toward one another by a compression mechanism, for example as described in U.S. Pat. No. 6,311,601, which is incorporated by reference as if fully set forth herein. Additional examples of embodiments of the creasing module 120 are described hereinbelow with respect to FIGS. 2A and 2B.

A cutting module 130 is adapted to make one or more cuts in the substrate along the crease line to form the fold line. The cut or cuts have a depth that is less than the thickness of the substrate at the crease line, so that the crease line is weakened but is not broken.

The cutting module 130 includes a cutting mechanism 132 that makes the cuts in the substrate. The cutting mechanism 132 may be any suitable cutting mechanism having sufficient accuracy to cut in the proper location along the crease line. For example, the cutting mechanism 132 may include a mechanical cutter, such as a knife or a rotating cutting disk, a laser module, and/or a jet stream cutter.

In some embodiments, the creasing module 120 and the cutting module 130 affect the substrate in a single station, without moving thereof. For example, the crease line may be impressed onto the substrate by compression thereof between the die and counter die, following which the compression mechanism separates the die and counter die to reveal the substrate. When the substrate is revealed, while it is still disposed between the die and counter die, a laser module forming part of cutting module 130 is used to make the cuts along the crease line.

In other embodiments, such as the embodiment illustrate in FIG. 1, the creasing module 120 and the cutting module 130 are located at two separate stations. In some such embodiments, following impression of the crease line on the substrate, and while the substrate is still aligned in the desired orientation, the substrate is moved to the cutting module for cutting thereof. In other such embodiments, at least one cut in the substrate is initially made at the cutting module, and while the substrate is still aligned in the desired orientation it is moved to the creasing module, which then impresses a crease line along the at least one cut.

The system 100 may further include an output module 140, for removing from the system substrates on which a fold line was formed by the creasing module 120 and the cutting module 130. In some embodiments, when fold lines are formed on multiple substrates, the substrates are stacked at the output module 140.

A conveyance mechanism 150, such as a conveyor belt, is adapted to convey the substrate from the input module 110 to the creasing module 120 and from the cutting module 130 to the output module 140. In embodiments in which the creasing module 120 and the cutting module 130 are at two different stations, such as in the illustrated embodiment, the conveyance mechanism also conveys the substrate from the creasing module 120 to the cutting module 130. The conveyance mechanism is selected so as to maintain the desired orientation of the substrate during conveyance thereof, at least between the creasing module 120 and the cutting module 130, so as to ensure proper placement of the cut on the crease line formed by the creasing module.

A controller 160 is functionally associated with the input module 110, creasing module 120, cutting module 130, and output module 140. The controller 160 is adapted to control the function of the creasing and cutting modules and to ensure coordination thereof. The controller 160 further controls the conveyance mechanism 150, for example to ensure proper alignment of the substrate and/or to monitor and adjust the speed or timing of the conveyance mechanism. The controller may be a general purpose computer with dedicated software, or may be a dedicated electronic module, which may be programmable by the user or pre-programmed.

Reference is now made to FIGS. 2A and 2B, which are schematic cross-sectional diagrams of embodiments of creasing module 120 forming part of the system 100 of FIG. 1 in accordance with aspects of the present invention.

As seen in FIG. 2A, the creasing module 120a includes a die 122a, which in the embodiment of FIG. 2A is a male die, mounted onto a base 200. The die 122a has a contact surface 202 defining the relief pattern to be impressed onto the substrate so as to form a crease line thereon. In some embodiments, the die 122a is a rule die, such that contact surface 202 includes one or more rules 204. The base 200 may be a flat, or planar base, as illustrated in FIG. 2A, or may be a rotating drum.

The die 112a and/or the portion thereof defining the relief pattern, such as rules 204, may be formed of metal, a polymeric material, or any other suitable material, and may be created using any suitable mechanism, including ink jet printing, three dimensional printing, milling, casting, sintering, or using Surface Adhesive Rule Technology as described in PCT application publication number WO2011/145092 filed May 17, 2011 and entitled “Method and System for Surface Adhesive Rule Technology”, in PCT application publication number WO2015/155685 filed Apr. 7, 2015 and entitled “Polymeric Rule Die, and Formulations Therefor”, and in PCT application publication number WO2013/030828 filed September 3, 2012 and entitled “Method and System for a Multiple Orifice Nozzle”, all of which are incorporated by reference as if fully set forth herein. In some embodiments, the rules 204 may be formed of a different material than the die 122a.

Disposed opposite die 122a, and spaced therefrom, is a counter die 124a which comprises a multi-layered compressible counter film mounted onto a base 206. The compressible counter film may include a base layer 208 adjacent base 206, a contact layer 210, disposed opposite the contact surface 202 of die 122a, and a compressible layer 212 disposed between base layer 208 and contact layer 210. Details relating to the various layers of the counter die 124a, and other possible layers which may be included in the counter die 124a, are described in PCT application number PCT/IB2017/053087, filed May 25, 2017 and entitled “System for Impressing a Relief Pattern on a Substrate”, which is incorporated by reference as if fully set forth herein.

The counter die 124a is featureless, or a plain flat film, in an area opposing the relief pattern or rules 204 of the die 122a. In some embodiments, the counter die 124a, or at least contact layer 210, is completely featureless, whereas in other embodiments the counter die 124a may include one or more features, whether features of a male die, a female die, textures, or any other features, in an area which does not oppose the relief pattern of the die 122a.

A compression mechanism is functionally associated with die 122a and with counter die 124a, or with bases 200 and 206 thereof, and is adapted to move the die 122a and the counter die 124a towards one another, as indicated by arrows 214. The compression mechanism may be any suitable compression mechanism, such as a gear based mechanism or a hydraulic mechanism.

In use, a substrate 216 is placed between contact surface 202 of die 122a and contact layer 210 of counter die 124a, and the compression mechanism moves die 122a and counter die 124a towards one another, such that the die engages a first surface 218 of the substrate and the contact layer 210 of the counter die 124a engages an opposing surface 220 of the substrate so as to impress the one or more crease lines defined by contact surface 202 on the substrate 216.

Turning to FIG. 2B, it is seen that a creasing module 120b a die 122b, mounted onto a base 230, the die 122b having a female-die contact surface 232 including at least one cavity or channel 234 defining a rule relief pattern, to be impressed onto the substrate so as to form the crease line. The base 230 may be a flat, or planar base, as illustrated in FIG. 2B, or may be a rotating drum.

The die 122b and/or the portion thereof defining the relief pattern, such as cavity 234, may be formed of metal, a polymeric material, or any other suitable material, and may be created using any suitable mechanism, including ink jet printing, three dimensional printing, etching, or mechanical cutting, for example by a computer numerical control (CNC) machine. In some embodiments, the die 122b and/or the portion thereof defining the relief pattern may be formed using Surface Adhesive Rule Technology, for example as described in Applicants PCT Application Publication no. WO2011/145092 filed May 17, 2011 and entitled “Method and System for Surface Adhesive Rule Technology”.

Disposed opposite die 122b, and spaced therefrom, is a counter die 124b, which in the illustrated embodiment is a male die film. In the illustrated embodiment, the counter die 124b includes a flexible male-die contact surface 235 and is mounted on a base 236. The counter die 124b may comprise a resilient, incompressible film 238, as illustrated in FIG. 2B, or may be a compressible film including multiple layers. Details relating to embodiments of the counter die 124b, characteristics thereof, and various possible layers which may be included in the counter die 124b, are described in PCT application number PCT/IB2017/053089, filed May 25, 2017 and entitled “System for Creating a Relief Pattern on a Substrate”, which is incorporated by reference as if fully set forth herein.

The counter die 124b is featureless, or a plain flat films, at least in an area opposing the relief pattern of the die 122b. In some embodiments, the counter die film 124b, or at least contact surface 235 thereof, is completely featureless, whereas in other embodiments the counter die film 124b may include one or more features, whether features of a male die, a female die, textures, or any other features, in an area which does not oppose the relief pattern of the die 122b.

A compression mechanism is functionally associated with die 122b and with counter die 124b, or with bases 230 and 236 thereof, and is adapted to move the die 122b and the counter die 124b towards one another, as indicated by arrows 244. The compression mechanism may be any suitable compression mechanism, such as a gear based mechanism or a hydraulic mechanism.

In an operative mode, a substrate 246 is placed between contact surface 232 of die 122b and contact surface 235 of counter die 124b, and the compression mechanism moves die 122b and counter die 124b towards one another, such that the contact surface 232 of die 122b engages a first surface 248 of the substrate and the contact surface 235 of counter die 124b engages an opposing surface 250 of the substrate so as to impress the crease line defined by one or more cavities 234 of contact surface 232 on the substrate 246. Specifically, in the operative mode, the substrate 246 is urged by counter die film 124b into one or more cavities 234 of die 122b, thereby to form the crease line on the substrate 246.

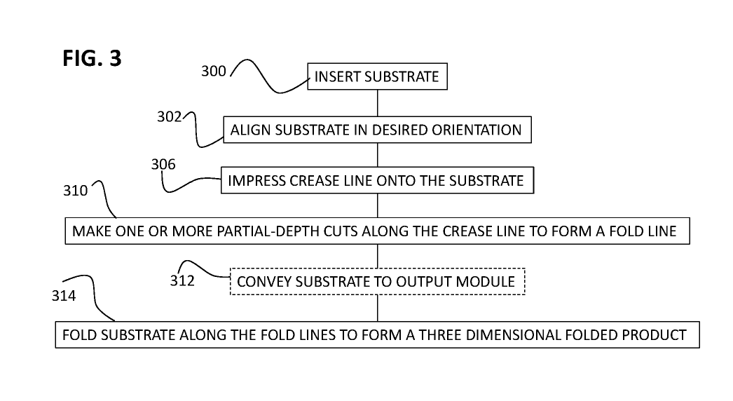

FIG. 3 is a flow chart of a method for forming a fold line in a substrate and for forming a three dimensional folded product. The method is described hereinbelow with respect to a single substrate and/or folded product. However, it is appreciated that the method of FIG. 3 may equally be carried out on a plurality of substrates and/or folded products. The substrate may be any suitable substrate, and in some embodiments may be a fibrous substrate such as paperboard, boxboard, cardboard, or corrugated cardboard.

As seen in FIG. 3, initially a substrate is inserted into a system for forming a fold line, at step 300. For example, the substrate may be inserted into an input module (110, FIG. 1). At step 302 the substrate is aligned in a desired orientation, for example manually or by an alignment module (114, FIG. 1).

The substrate is provided to a creasing module (120, FIG. 1) for impressing a crease line thereon, for example by a feeding module (116, FIG. 1) and/or a conveyance mechanism (150, FIG. 1), and one or more crease lines are then impressed onto the substrate by the creasing module at step 306, by compressing the substrate between the die (122, FIG. 1) and counter die (124, FIG. 1) of the creasing module.

In some embodiments, the substrate is optionally conveyed from the creasing module to a cutting module (124, FIG. 1), for example by the conveyance mechanism, while maintaining the orientation of the substrate. One or more cuts are made along the crease line by the cutting module at step 310, thereby to form a fold line. Each such cut has a depth that is less than the thickness of the substrate at the crease line, or, stated differently, does not penetrate through the entire thickness of the substrate.

It is appreciated that maintaining the orientation of the substrate while it is being conveyed from the creasing module to the cutting module, if such conveyance is required, is critical to proper alignment of the cut or cuts on the crease line, preferably at a center thereof.

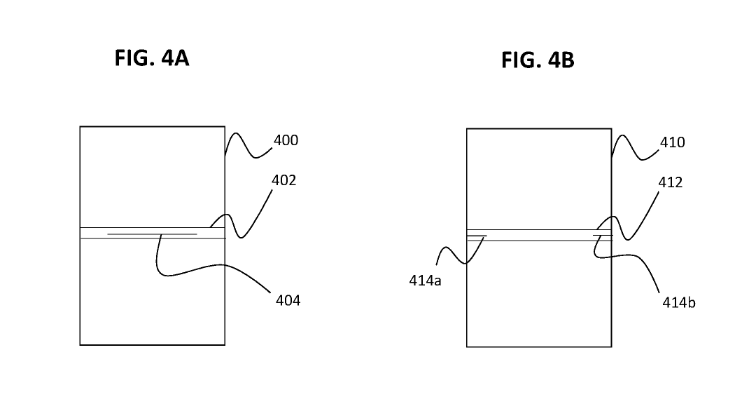

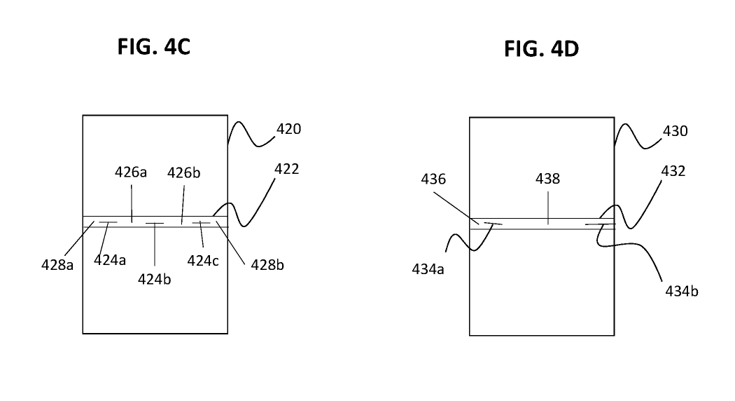

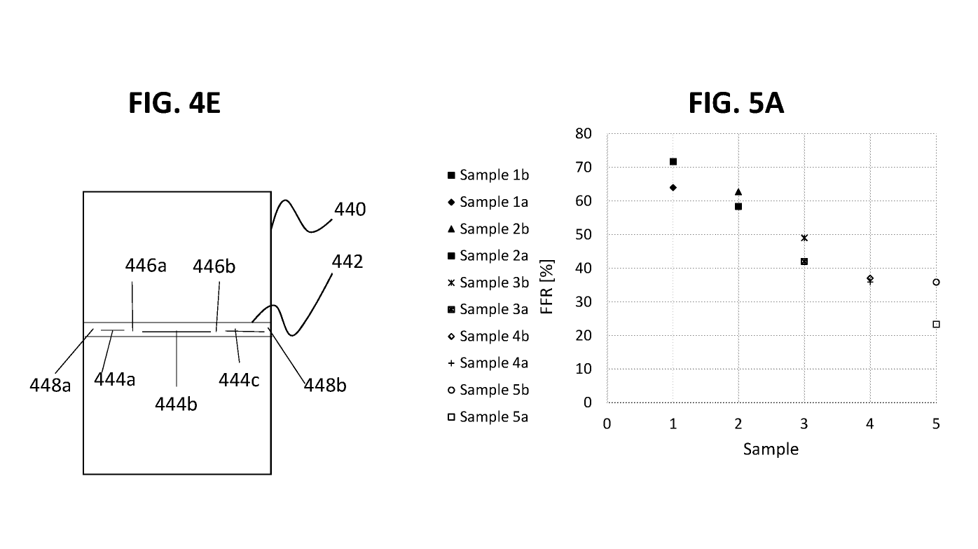

In some embodiments, the one or more cuts include a single cut extending along the entire length of the crease line. In other embodiments, such as those described hereinbelow with reference to FIGS. 4A to 4D, the total length of the cut or cuts is less than the length of the crease line. In some embodiments, a total length of the at least one cut is at most 75%, at most 60%, at most 50%, or at most 40% of a length of the crease line. In some embodiments, a total length of the at least one cut is within the range of 10%-75%, 10%-60%, 10%-50%, 20%-50%, 25%-50%, or 25%-40% of a length of the crease line.

In some embodiments, one or more cuts include a single cut disposed in the crease line, such that two uncut margins, which may be equally or differently sized, flank the cut in the crease line. One such example is illustrated in FIG. 4A, in which a substrate 400 includes a crease line 402, which is cut along a segment 404 at the center thereof. In the illustrated embodiment, the crease line is 40 mm long, and the cut is 30 mm long, leaving 5 mm wide uncut margins on either side of the cut.

In some embodiments, one or more cuts include two cuts disposed at edges of the crease line, such an uncut segment is disposed between the two cuts. One such example is illustrated in FIG. 4B, in which a substrate 410 includes a crease line 412, which is cut along segments 414a and 414b at edges thereof In the illustrated embodiment, the crease line is 40 mm long, and the cuts are each 5 mm long, leaving a 30 mm wide uncut center segment.

In some embodiments, one or more cuts comprise a dashed cut, which includes multiple short cuts each separate by an uncut region. In some embodiments, the short cuts are all equally sized and the uncut regions are all equally sized. One such example is illustrated in FIG. 4C, in which a substrate 420 includes a crease line 422, which is cut along a segments 424a, 424b, and 424c separated by uncut regions 426a, 426b and flanked by uncut margins 428a and 428b. In the illustrated embodiment, the crease line is 40 mm long, each cut is 2 mm long, and each uncut portion is 8.5 mm wide.

In some embodiments, one or more cuts include multiple cuts of various lengths are disposed at along the crease line, with uncut segment disposed between cuts, the uncut segments also having various lengths. Such examples are illustrated in FIGS. 4D and 4E.

In FIG. 4D, a substrate 430 includes a crease line 432, which is cut along segments 434a and 434b, segment 434b being at an edge of the crease line 432. An uncut margin 436 extends from an edge of the crease line to segment 434a, and an uncut segment 438 extends between segments 434a and 434b. In the illustrated embodiment, the crease line is 40 mm long, margin 436 is 4 mm long, cut segment 434a is 2 mm long, segment 438 is 30 mm long, and cut segment 434b is 4 mm long.

In FIG. 4E, a substrate 440 includes a crease line 442, which is cut along segments 444a, 444b, and 444c. The segments 444a, 444b, and 444c are separated by uncut segments 446a and 446b, and uncut margins 448a and 448b extend from a first edge of the crease to cut segment 444a and from cut segment 444c to a second edge of the crease, respectively. In the illustrated embodiment, the crease line is 40 mm long, margin 448a is 2 mm long, cut segment 444a is 4 mm long, segment 446a is 3 mm long, cut segment 444b is 18 mm long, segment 446b is 5 mm long, cut segment 444c is 6.5 mm long, and margin 448b is 1.5 mm long.

In some embodiments, the depth of the cut is at least 5%, at least 10%, or at least 15% of the thickness of the substrate at the crease line. In some embodiments, the depth of the cut is at most 70%, at most 60%, at most 50%, at most 40%, at most 30%, or at most 25% of the thickness of the substrate at the crease line. In some embodiments, the depth of the cut in the range of 5%-70%, 5%-60%, 5%-50%, 5%-40%, 7%-40%, 10%-40%, 12%-40%, 15%-40%, 10%-35%, 12%-35%, 15%-35%, 10%-30%, 12%-30%, 15%-30%, or 15%-25%of the thickness of the substrate at the crease line.

In some embodiments, the greater the depth of the cut, the greater the reduction in the folding force required to fold the substrate, as demonstrated hereinbelow in Example 3. Additionally, the greater the length of the cut, the greater the reduction in folding force required to fold the substrate, as demonstrated hereinbelow in Examples 1 and 2. However, a deeper cut also wounds and/or weakens the substrate more than a less deep cut. Additionally, a deeper cut also warps or completely destroys the bead shape of the crease line than a less deep cut. Furthermore, if the folding force required to fold the substrate it too low, the fold may not be strong enough when the substrate is folded (and may flop back open or fold over more than the necessary amount), and if the substrate is folded by a machine, the machine may apply too much force for folding the substrate and may damage the substrate. As such a balance should be found as to the ideal depth of cutting, ideal portion of the length of the substrate that is cut, and ideal folding force of the fold line formed by the partially cut crease line. In some embodiments, the ideal depth depends on the strength of the substrate, the thickness of the substrate, the fiber structure of the substrate, characteristics of the creasing module, and the like.

In some embodiments, a folding force of the fold line is in the range of 30%-65%, 30%-60%, 35%-60%, 40%-60%, 45%-60%, or 45%-55% of a folding force of the crease line prior to cutting thereof.

In some embodiments, a variation of the depth of the at least one cut along the at least one cut is within 15%, within 10%, within 8%, or within 5% of the thickness of the substrate. In some embodiments, a variation of the depth of the at least one cut along the at least one cut is within 15%, within 10%, within 8%, or within 5% of the depth of the at least one cut.

In some embodiments, the cut is disposed at a center of a cross section of the crease line. In some embodiments, the cut is disposed at a minimum point of a cross section of the crease line.

In some embodiments, a bead of the crease line is visible along an entire length of the fold line. In some embodiments, a bead of the crease line is visible in sections of the crease line including the at least one cut.

It is appreciated that, in some embodiments, order of steps 306 and 310 may be reversed. In such embodiments, one or more cuts are made in the substrate, and subsequently the substrate is provided to the creasing module and a crease line is impressed along a line including the one or more cuts.

Following formation of the fold line, in some embodiments, at step 312, the creased and cut substrate is conveyed, for example by the conveyance mechanism, to an output module (140, FIG. 1), where multiple products may be stacked one upon the other. At some later stage, a human operator may take the stacked substrates from the output module, and may fold each one along the fold line, either manually or using a dedicated folding system.

At step 314, the substrate is folded along the one or more fold lines formed by the creasing and cutting modules and a three dimensional folded product is formed. In some embodiments, formation of the three dimensional folded product only requires folding the substrate along the fold lines. In some embodiments, forming the three dimensional product includes folding the substrate along additional crease lines which have not been cut. In some embodiments, additional components are added to the substrate, or multiple substrates are combined, to form the three dimensional product.

Folding of the substrate at step 314 may be carried out by a folding module integrated into the system (100, FIG. 1) that forms the fold line in the substrate, by a dedicated automatic folding system, or may be carried out manually or partially manually.

As demonstrated in the Examples provided hereinbelow, forming a fold line in the substrate, as described hereinabove, reduces the folding force required in order to fold the substrate, relative to the folding force required to fold the substrate on the crease line without the crease line being cut.

As such, the method of FIG. 3 is particularly useful for substrates and/or in situations where a lot of force is required to fold the substrate, or where the folding force is high.

Examples of substrates for which the method of FIG. 3 would be useful include: folding boxboard having a thickness of at least 500 μm, at least 550 μm, at least 600 μm, or at least 650 μm, such as high bulk paper or Incada Exel commercially available from Iggesund Paperboard of Germany;

kraft paper having a thickness of at least 500 μm, at least 550 μm, at least 600 μm, or at least 650 μm, such as Coated Natural Kraft (CNK) Custom Kote paperboard paperboard commercially available from WestRock of Norcross, Ga., USA; and

Laminated paper or board having a thickness of at most 400 μm, at most 350 μm, at most 300 μm, at most 250 μm, such as chromo paper. The laminated paper or board may be laminated upon production thereof, or may be laminated by the end user, for example following printing on the paper or processing thereof.

There are many situations in which the method of FIG. 3 may be useful, and reduce the folding force of the substrate so as to ease the folding of a substrate that previously had a high folding force.

For example, the method of forming a fold line as described hereinabove, to reduce the required folding force, may be particularly useful when the layout of the substrate includes many creases, which may be relatively close to one another. This is particularly important when using the creasing modules of FIGS. 2A and/or 2B, as the counter die 124 of these creasing modules is a unfeatured die blanket, which is not dedicated to a single relief pattern but rather divides itself between multiple crease lines and as such less pressure is applied by the blanket along each relief pattern and the crease lines are less well defined. This may not be the case when using a die including a rule and a counter die including a correspondingly shaped channel, since in such a creasing module the pressure applied by the die and/or counter die to the substrate is independent of the number of crease lines in the layout of the substrate.

As another example, the method of FIG. 3 is useful when the direction of the fibers of the substrate is perpendicular to the machine direction, or to the direction of motion of the substrate. In this case, the machine typically creates the crease line in the cross grain direction, resulting in a crease line that requires higher folding force than a crease line in the grain direction, which folding force can be reduced by adding one or more cuts to the crease line, as described above.

Additionally, when the substrate is dry paperboard or boxboard and tends to split or rip, the creasing module must apply less pressure than when using less dry paper, so as to prevent splitting of the paper. This typically results in a less well-defined crease line, which tends to have a higher folding force, so that making partial cuts along the crease line may reduce the required folding force and allow for easier folding at the crease line or fold line.

Furthermore, the method of FIG. 3 may be useful to reduce the folding force when using a corrugated substrate, such as corrugated cardboard. For example, in cases in which the crease line is aligned along a ridge or a furrow of the corrugation, the crease would have a low folding force. However, when the crease is not aligned with a ridge or furrow, such as when the crease is aligned with a slope of the corrugation or crosses a number of ridges and furrows of the corrugation (in the cross direction to the corrugation or angled with respect thereto), often a high folding force is required and use of partial cuts, as described hereinabove, can greatly reduce the required folding force.

### EXAMPLES

Reference is now made to the following examples, which together with the above description, illustrate the invention in a non-limiting fashion.

### Example 1

Multiple samples of Incada Exel GC2 490 μm Folding Box Board paper commercially available from Iggesund of Sweden and having a width of 40 mm were creased on a Euclid 3 digital creasing and cutting machine commercially available from Highcon LTD. of Yavne, Israel, using a counter film including a 0.25 mm PET base layer and a 1.75 mm polyurethane layer, and having a Shore A hardness value of 69.

Creasing was performed on a rotational Digital Adhesive Rule Technology (DART) system using Euclid DART photopolymer rules with a rule penetration depth of 1.5 mm. In half the samples the crease was made such that the grain direction was in the machine direction (MD), and in the other half the crease was made such that the grain direction was in the cross machine direction. The crease extended from one end of the sample paper to the opposite end of the sample paper.

In each sample other than the reference samples, a single cut was made at the center of the crease line, the cut extending to 60% of the depth of the boxboard and having equally sized margins on either side thereof, for example as illustrated in FIG. 4A.

Prior to cutting, the samples were divided into pairs of MD and CMD samples, and for each pair of samples the size of the cut and of the margins were the same for both samples in the pair, and different from all samples of the other pairs. The cut was arranged to be aligned with the lowest point of the crease line. One MD sample and one CMD sample remained uncut, as a reference. Table 1 summarizes the samples and the dimensions of the cuts and margins thereof

TABLE 1

| Sample No. | Direction | Margin size (mm) | Cut size (mm) |
|---|---|---|---|
| 1a (reference) | MD | 20 | 0 |
| 1b (reference) | CMD | 20 | 0 |
| 2a | MD | 15 | 10 |
| 2b | CMD | 15 | 10 |
| 3a | MD | 10 | 20 |
| 3b | CMD | 10 | 20 |
| 4a | MD | 5 | 30 |
| 4b | CMD | 5 | 30 |
| 5a | MD | 2.5 | 35 |
| 5b | CMD | 2.5 | 35 |

The folding performance of the creased and cut boxboard was measured on a 1270 PCA Score Bend/Opening Force Tester commercially available from Thwing Albert Instrument Company of West Berlin, N.J., USA, which provides a TAPPI T577 Score Bend Test Standard for determining the score bend resistance of scored (creased) and cut (creased and cut) paperboard samples, for calculation of a score ratio. Specifically, the score ratio test was carried out as a two-cycle bending test. During the first cycle the scored and cut sample was bent to a specific stop angle of 90 degrees, and was then returned to the starting position (an angle of 0 degrees). The process was repeated for a creased, but uncut reference sample of the same paper and in the same direction (MD or CMD), as well as for a plain paper sample (that hasn't been creased or cut) and in the same direction (MD or CMD). For all samples other than the reference samples, the score ratio was calculated as ratio of the peak bending force for the cut paperboard to the peak bending force of the uncut paperboard, in percentages. For the reference samples, score ratio was calculated as ratio of the peak bending force for the creased reference paperboard to the peak bending force of the plain (not cut or creased) paperboard, in percentages.

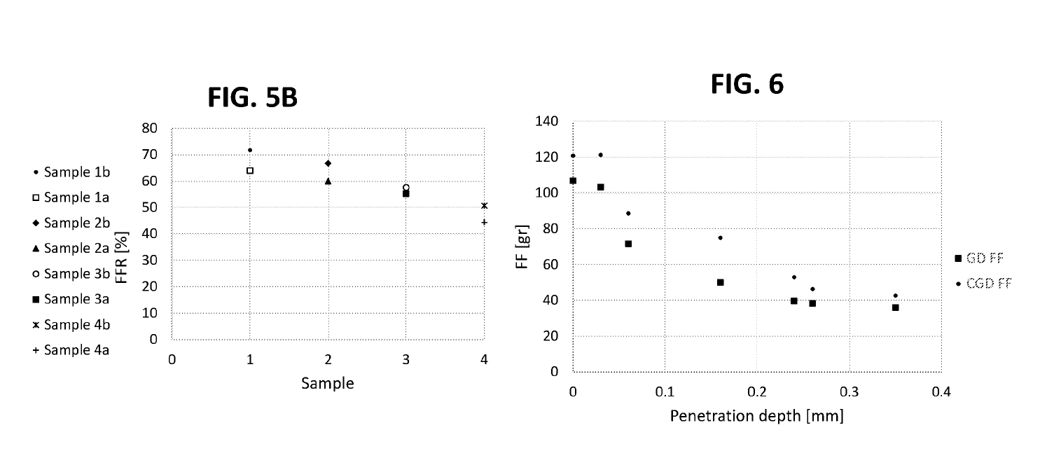

The results of the test of Example 1, are illustrated in FIG. 5A, which is a graphic representation in which each of the samples is associated with a different marker, and where the x-axis indicates the sample number and the y-axis indicates the score ratio percentage, such that the higher the value on the y-axis, the closer the folding force of the sample is to that of the reference.

As seen in FIG. 5A, the greater the length of the cut, the greater the reduction in the folding force required to fold the paper along the fold line.

Additionally, as seen, the folding force ratio of samples 2 and 3, in which the length of the cut is 25%-50% of the entire length of the crease line, is in the range of 40%-65%. the folding force ratio of samples 4 and 5, in which the length of the cut is 75%-90% of the length of the crease line, is less than 40%.

### Example 2

The experiment of Example 1 was repeated with the same paper and machinery, where instead of each sample other than the reference sample having a single cut at the center thereof, two cuts were made at the edges of the crease line leaving an uncut segment of the crease line between the two edge cuts, for example as illustrated in FIG. 4B. The edge cuts extended to 60% of the depth of the boxboard.

As in Example 1, Prior to cutting, the samples were divided into pairs of MD and CMD samples, and for each pair of samples the size of the edge cut and of the uncut center segment were the same for both samples in the pair, and different from all samples of the other pairs. The cuts were arranged to be aligned with the lowest point of the crease line. One MD sample and one CMD sample remained uncut, as a reference. Table 2 summarizes the samples and the dimensions of the edge cuts and center segments thereof.

TABLE 2

| | | Margin cut | Center segment |
|---|---|---|---|
| Sample No. | Direction | size (mm) | size (mm) |
| 1a (reference) | MD | 0 | 40 |
| 1b (reference) | CMD | 0 | 40 |
| 2a | MD | 2 | 36 |
| 2b | CMD | 2 | 36 |
| 3a | MD | 5 | 30 |
| 3b | CMD | 5 | 30 |
| 4a | MD | 10 | 20 |
| 4b | CMD | 10 | 20 |

As in Example 1, the folding performance of the creased and cut samples was measured in comparison to the folding performance of the creased reference samples. The results of the test of Example 2, are illustrated in FIG. 5B, which is a graphic representation of the same structure as that of FIG. 5A.

As seen in FIG. 5A, the greater the length of the edge cuts, the greater the reduction in the folding force required to fold the paper along the fold line.

Additionally, as seen, the folding force ratio of samples 2, 3, and 4, in which the length of the cut is 10%-50% of the entire length of the crease line, is in the range of 40%-68%.

As discussed hereinabove, it is advantageous for the folding force required to fold the substrate to be in a specific range of values, which the inventors have found to be in the range of 40%-70%, or preferably 45%-65% of the folding force required for a reference sample. If the folding force required to fold the substrate it too low, the fold may not be strong enough when the substrate is folded (and may flop back open or fold over more than the necessary amount), and if the substrate is folded by a machine, the machine may apply too much force for folding the substrate and may damage the substrate. As such, and based on the results of the experiments of Examples 1 and 2, the Applicants have found that the greatest advantage would be achieved from having the cut or cuts extend along 10%-50%, 15%-50%, or 25%-50% of the length of the crease line.

### Example 3

Multiple samples of Incada Exel GC2 490 μm Folding Box Board paper commercially available from Iggesund of Sweden and having a width of 40 mm were creased on a Euclid 3 digital creasing and cutting machine commercially available from Highcon LTD. of Yavne, Israel, using a counter film including a 0.25 mm PET base layer and a 1.75 mm polyurethane layer, and having a Shore A hardness value of 69.

Creasing was performed on a rotational Digital Adhesive Rule Technology (DART) system using Euclid DART photopolymer rules with a rule penetration depth of 1.5 mm. In half the samples the crease was made in the grain direction (GD), and in the other half the crease was made in the cross grain direction. The crease extended from one end of the sample paper to the opposite end of the sample paper.

In each sample other than the reference samples, a single cut was made at the center of the crease line, the cut having a length of 30 mm and leaving uncut margins of 5 mm on either side of the cut, for example as illustrated in FIG. 4A. The percentage of intensity of the cutting laser was changed for different samples, such that different depths of cuts resulted in the various samples, as shown herein. The machine was pre-calibrated to ensure than at 100% laser intensity the cut extended through the entire depth of the paper.

Prior to cutting, the samples were divided into pairs of GD and CGD samples, and for each pair of samples the cutting laser was used at the same intensity percentage for both samples in the pair, and at a different intensity percentage from that of samples of the other pairs. The cut was arranged to be aligned with the lowest point of the crease line. One GD sample and one CGD sample remained uncut, as a reference.

The effect of the cut on the shape of the bead of the crease line was qualitatively observed.

Table 3 shows the correlation between the percentage of laser intensity used for making the cut, the depth of the cut in mm, and the effect of the cut on the bead of the crease line, where the depth of the cut was measured based on a photograph of the crease and cut captured using Creasy commercially available from Peret GmbH of Varna, Italy.

TABLE 3

| Intensity of | | Affect of cut on bead |
|---|---|---|
| cutting laser (%) | Cut depth (mm) | of crease line |
| 0 | 0 | No impact |
| 10 | 0.03 | No impact |
| 30 | 0.06 | Bead warped |
| 50 | 0.16 | Bead disappeared |
| 70 | 0.24 | Bead disappeared |
| 90 | 0.26 | Bead disappeared |
| 100 | 0.35 | Bead disappeared |

The folding performance of the creased and cut boxboard was measured on a 1270 PCA Score Bend/Opening Force Tester commercially available from Thwing Albert Instrument Company of West Berlin, N.J., USA, which provides a TAPPI T577 Score Bend Test Standard for determining the score bend resistance of scored (creased) and cut (creased and cut) paperboard samples. For each sample, as well as for the reference uncut samples and for the fully cut samples, the sample was bent to a specific stop angle of 90 degrees, and was then returned to the starting position (an angle of 0 degrees).

The results of the test of Example 3, are illustrated in FIG. 6, which is a graphic representation where the x-axis indicates the penetration depth of the cut (in mm), the y-axis indicates the measured folding force (in grams), and different colors indicate samples in which the crease was in GD and in CGD.

As seen in FIG. 6, the folding force required to fold the boxboard decreases as the depth of the cut increases, until a point where increasing the depth of the cut no longer significantly improves the folding force, and only weakens the paper and the crease, while requiring investment of a greater amount of energy to operate the cutting mechanism. Under the conditions of the experiment of Example 3, that point is at a penetration depth of 0.24 mm, which is equivalent to 70% of the intensity of the laser.

Additionally, as seen in Table 3, the bead of the crease line was warped at 30% of the intensity of the laser, and has completely disappeared at 50% of the intensity of the laser. The disappearance of the bead detrimentally affects the quality and aesthetics of the resulting fold, and as such, it would be beneficial to use cuts which maintain the shape of the bead, or at least do not completely destroy the shape of the bead.

Furthermore, as discussed hereinabove with respect to Examples 1 and 2, ideally the folding force of the fold line (crease line having one or more partial cuts therealong) is reduced to 40% to 70%, or 45% to 65%, of the folding force of a reference including only a crease line. As seen in FIG. 6, this occurs when the intensity of the laser is between 30% and 50%.

As such, it is advantageous to cut the crease line of Example 3 at a laser intensity of 30% to 70%, and preferably 30% to 50%, which provides substantially the maximal improvement in the folding force while maintaining as much of the integrity of the crease and of the paper as possible so as to maintain the strength of the crease and the fold resulting therefrom. It is appreciated that the cut depth at which the folding force no longer improves may vary between paper types, crease types, and cut arrangements, and can be found using an experiment as described hereinabove for each specific application.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, including PCT application publication number WO2011/145092, PCT application publication number WO2015/155685, PCT application publication number WO2013/030828, PCT application number PCT/IL2017/053087, and PCT application number PCT/IL2017/053089, are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for creating a fold line in a substrate, the system comprising:
a creasing module including a die, a counter die, and a compression mechanism, said creasing module adapted to impress at least one crease line onto the substrate by compressing the substrate between said die and said counter die by means of said compression mechanism; and
a cutting module adapted to make at least one cut in the substrate, said at least one cut having a depth less than a thickness of the substrate at said crease line, said crease line and said at least one cut being at least partially overlapping so as to form the fold line,
wherein said depth of said at least one cut is in the range of 5% to 70% of said thickness of the substrate at said crease line.

2. The system of claim 1, wherein said substrate is impacted by said creasing module prior to being impacted by said cutting module, and wherein said cutting module is adapted to make said at least one cut along said crease line.

3. The system of claim 1, wherein said substrate is impacted by said cutting module prior to being impacted by said creasing module, and wherein said creasing module is adapted to impress said crease line onto said substrate along said at least one cut.

4. The system of any one of claims 1 to 3, wherein said die includes at least one rule and said counter die comprises a counter film which is featureless in a region thereof opposing said at least one rule.

5. The system of any one of claims 1 to 3, wherein said die includes at least one channel and said counter die comprises a counter film which is featureless in a region thereof opposing said at least one channel

6. The system of any one of claims 1 to 3, wherein said die includes at least one rule and said counter die includes at least one channel corresponding in shape and positioning to said at least one rule.

7. The system of any one of the preceding claims, wherein said cutting module includes at least one mechanical cutter.

8. The system of any one of claims 1 to 6, wherein said cutting module includes a laser module.

9. The system of any one of claims 1 to 6, wherein said cutting module includes a jet stream cutter.

10. The system of any one of the preceding claims, further comprising:
an input module adapted to align the substrate in a desired orientation and to feed the aligned substrate to the creasing module; and
a conveyance mechanism adapted to convey the substrate to said creasing module while the substrate remains in said desired orientation.

11. The system of claim 10, wherein said creasing module forms part of a creasing station, and said cutting module forms part of a cutting station, and said conveyance mechanism is adapted to convey the substrate from said creasing station to said cutting station while the substrate remains in said desired orientation.

12. The system of claim 10 or claim 11, further comprising an output module adapted to receive the substrate following cutting thereof by said cutting module, wherein the conveyance mechanism is further adapted to convey the substrate from the cutting module to the output module.

13. The system of claim 12, wherein the substrate includes multiple sheets of the substrate, wherein said multiple sheets are stacked in said desired orientation at said input module, and wherein said conveyance mechanism is adapted to convey each of the sheets of the substrate, in said desired orientation, from said input module to said creasing module for impressing said at least one crease line thereonto and to convey each of said multiple sheets of the substrate, following cutting thereof, from said cutting module to said output module to be stacked thereon.

14. The system of any one of the preceding claims, wherein a total length of said at least one cut is less than a length of said crease line.

15. The system of any one of the preceding claims, wherein a total length of said at least one cut is at most 75%, at most 60%, at most 50%, or at most 40% of a length of said crease line.

16. The system of any one of the preceding claims, wherein a total length of said at least one cut is within a range of 10%-75%, 10%-60%, 10%-50%, 20%-50%, 25%-50%, or 25%-40% of said length of said crease line.

17. The system of any one of the preceding claims, wherein said at least one cut comprises a single cut disposed at a center of said crease line.

18. The system of any one of claims 1 to 16, wherein said at least one cut comprises two cuts disposed at edges of said crease line and having a non-cut area therebetween.

19. The system of any one of claims 1 to 16, wherein said at least one cut comprises a plurality of cuts regularly spaced along said crease line.

20. The system of any one of the preceding claims, wherein said depth of said at least one cut is at least 10%, or at least 15% of said thickness of the substrate at said crease line.

21. The system of any one of the preceding claims, wherein said depth of said at least one cut is at most 60%, at most 50%, at most 40%, at most 30%, or at most 25% of said thickness of the substrate at said crease line.

22. The system of any one of claims 1 to 19, wherein said depth of said at least one cut is in the range of 5%-60%, 5%-50%, 5%-40%, 7%-40%, 10%-40%, 12%-40%, 15%-40%, 10%-35%, 12%-35%, 15%-35%, 10%-30%, 12%-30%, 15%-30%, or 15%-25% of said thickness of the substrate at said crease line.

23. The system of any one of the preceding claims, wherein a folding force of said fold line is in the range of 30%-65%, 30%-60%, 35%-60%, 40%-60%, 45%-60%, or 45%-55% of a folding force of said crease line prior to cutting thereof.

24. The system of any one of the preceding claims, wherein a variation of said depth of said at least one cut along said at least one cut is within 15%, within 10%, within 8%, or within 5% of said thickness of said substrate.

25. The system of any one of the preceding claims, wherein a variation of said depth of said at least one cut along said at least one cut is within 15%, within 10%, within 8%, or within 5% of said depth of said at least one cut.

26. The system of any one of the preceding claims, wherein said at least one cut is disposed at a center of a cross section of said crease line.

27. The system of any one of the preceding claims, wherein said at least one cut is disposed at a minimum point of a cross section of said crease line.

28. The system of any one of the preceding claims, wherein a bead of said crease line is visible along an entire length of said fold line.

29. The system of any one of claims 1 to 27, wherein a bead of said crease line is visible in sections of said crease line including said at least one cut.

30. The system of any one of the preceding claims, wherein the substrate comprises a fibrous substrate.

31. The system of claim 30, wherein the substrate comprises cardboard.

32. The system of claim 30 or claim 31, wherein the substrate comprises a corrugated substrate.

33. The system of any one of the preceding claims, wherein the substrate has a thickness greater than 450 μm, greater than 500 μm, greater than 550 μm, greater than 600 μm, or greater than 650 μm.

34. The system of claim 30 or claim 31, wherein said fibrous substrate is a laminated fibrous substrate.

35. The system of claim 35, wherein said laminated fibrous substrate has a thickness less than 350 μm, less than 300 μm, less than 250 μm, or less than 200 μm.

36. A method for creating a fold line in a substrate, the method comprising:
impressing a crease line onto the substrate by compressing the substrate between a die and a corresponding counter die of a creasing module; and
making at least one cut in the substrate, said at least one cut having a depth less than the thickness of the substrate at said crease line,
wherein said crease line and said at least one cut at least partially overlap so as to form the fold line,
wherein said depth of said at least one cut is in the range of 5% to 70% of said thickness of the substrate at said crease line.

37. The method of claim 36, wherein said impressing a crease line occurs prior to said making at least one cut, and wherein said making at least one cut includes making said at least one cut along said crease line.

38. The method of claim 36, wherein said making said at least one cut occurs prior to said impressing a crease line, and wherein said impressing a crease line includes impressing said crease line along said at least one cut.

39. The method of any one of claims 36 to 38, wherein said making at least one cut comprises cutting the substrate using a mechanical cutter.

40. The method of any one of claims 36 to 38, wherein said making at least one cut comprises cutting the substrate using a laser module.

41. The method of any one of claims 36 to 38, wherein said making at least one cut comprises cutting the substrate using a jet stream cutter.

42. The method of any one of claims 36 to 41, further comprising:
aligning the substrate in a desired orientation; and
using a conveyance mechanism, feeding the substrate to the creasing module in a desired orientation.

43. The method of claim 42, wherein said impressing is carried out at a creasing station and said making at least one cut is carried out at a cutting station, the method further comprising conveying the substrate from said creasing station to said cutting station while the substrate remains in said desired orientation.

44. The method of any one of claims 36 to 43, wherein said making at least one cut comprises making at least one cut having a total length less than a length of said crease line.

45. The method of any one of claims 36 to 44, wherein a total length of said at least one cut is at most 75%, at most 60%, at most 50%, or at most 40% of a length of said crease line.

46. The method of any one of claims 36 to 44, wherein a total length of said at least one cut is within a range of 10%-75%, 10%-60%, 10%-50%, 20%-50%, 25%-50%, or 25%-40% of said length of said crease line.

47. The method of any one of claims 36 to 46, wherein said making at least one cut comprises making a single cut disposed at a center of said crease line.

48. The method of any one of claims 36 to 46, wherein said making at least one cut comprises making two cuts disposed at edges of said crease line and having a non-cut area therebetween.

49. The method of any one of claims 36 to 46, wherein said making at least one cut comprises making a plurality of cuts regularly spaced along said crease line.

50. The method of any one of claims 36 to 49, wherein said depth of said at least one cut is at least 10%, or at least 15% of said thickness of the substrate at said crease line.

51. The method of any one of claims 36 to 50, wherein said depth of said at least one cut is at most 60%, at most 50%, at most 40%, at most 30%, or at most 25% of said thickness of the substrate at said crease line.

52. The method of any one of claims 36 to 49, wherein said depth of said at least one cut is in the range of 5%-60%, 5%-50%, 5%-40%, 7%-40%, 10%-40%, 12%-40%, 15%-40%, 10%-35%, 12%-35%, 15%-35%, 10%-30%, 12%-30%, 15%-30%, or 15%-25% of said thickness of the substrate at said crease line.

53. The method of any one of claims 36 to 52, wherein a folding force of said fold line is in the range of 30%-65%, 30%-60%, 35%-60%, 40%-60%, 45%-60%, or 45%-55% of a folding force of said crease line prior to cutting thereof.

54. The method of any one of claims 36 to 53, wherein a variation of said depth of said at least one cut along said at least one cut is within 15%, within 10%, within 8%, or within 5% of said thickness of said substrate.

55. The method of any one of claims 36 to 54, wherein a variation of said depth of said at least one cut along said at least one cut is within 15%, within 10%, within 8%, or within 5% of said depth of said at least one cut.

56. The method of any one of claims 36 to 55, wherein said at least one cut is disposed at a center of a cross section of said crease line.

57. The method of any one of claims 36 to 56, wherein said at least one cut is disposed at a minimum point of a cross section of said crease line.

58. The method of any one of claims 36 to 57, wherein a bead of said crease line is visible along an entire length of said fold line.

59. The method of any one of claims 36 to 57, wherein a bead of said crease line is visible in sections of said crease line including said at least one cut.

60. The method of any one of claims 36 to 59, wherein the substrate comprises a fibrous substrate.

61. The method of claim 60, wherein the substrate comprises cardboard.

62. The method of claim 60 or claim 61, wherein the substrate comprises a corrugated substrate.

63. The method of any one of claims 36 to 62, wherein the substrate has a thickness greater than 450μm, greater than 500 μm, greater than 550μm greater than 600μm or greater than 650 μm.

64. The method of claim 60 or claim 61, wherein said fibrous substrate is a laminated fibrous substrate.

65. The method of claim 64, wherein said laminated fibrous substrate has a thickness less than 350 μm, less than 300 μm less than 250 μm or less than 200 μm.

66. A method of forming a three dimensional folded product from a substrate sheet, the method comprising:
creating a plurality of fold lines in the substrate sheet according to the method of any one of claims 36 to 65; and
folding the substrate sheet along said plurality of fold lines thereby to form the three dimensional folded product.

67. The method of claim 66, wherein said folded product comprises a box, a folder, or a greeting card.

68. A three dimensional folded product comprising at least one substrate sheet folded along at least one fold line, at least one of at least one fold line including a crease line having at least one cut formed therealong, said at least one cut having a depth less than the thickness of said substrate sheet at said crease line, said depth being with the range of 5% to 70% of said thickness of said substrate sheet.

69. The three dimensional folded product of claim 68, wherein said folded product comprises a box, a folder, or a greeting card.

70. The three dimensional folded product of claim 68 or claim 69, wherein a total length of said at least one cut is less than a length of said crease line.

71. The three dimensional folded product of any one of claims 68 to 70, wherein a total length of said at least one cut is at most 75%, at most 60%, at most 50%, or at most 40% of a length of said crease line.

72. The three dimensional folded product of any one of claims 68 to 70, wherein a total length of said at least one cut is within a range of 10%-75%, 10%-60%, 10%-50%, 20%-50%, 25%-50%, or 25%-40% of said length of said crease line.

73. The three dimensional folded product of any one of claims 68 to 72, wherein said at least one cut comprises a single cut disposed at a center of said crease line.

74. The three dimensional folded product of any one of claims 68 to 72, wherein said at least one cut comprises two cuts disposed at edges of said crease line and having a non-cut area therebetween.

75. The three dimensional folded product of any one of claims 68 to 72, wherein said at least one cut comprises a plurality of cuts regularly spaced along said crease line.

76. The three dimensional folded product of any one of claims 68 to 75, wherein said depth of said at least one cut is at least 10%, or at least 15% of said thickness of the substrate at said crease line.

77. The three dimensional folded product of any one of claims 68 to 76, wherein said depth of said at least one cut is at most 60%, at most 50%, at most 40%, at most 30%, or at most 25% of said thickness of the substrate at said crease line.

78. The three dimensional folded product of any one of claims 68 to 75, wherein said depth of said at least one cut is in the range of 5%-60%, 5%-50%, 5%-40%, 7%-40%, 10%-40%, 12%-40%, 15%-40%, 10%-35%, 12%-35%, 15%-35%, 10%-30%, 12%-30%, 15%-30%, or 15%-25% of said thickness of the substrate at said crease line.

79. The three dimensional folded product of any one of claims 68 to 78, wherein a folding force of said fold line is in the range of 30%-65%, 30%-60%, 35%-60%, 40%-60%, 45%-60%, or 45%-55% of a folding force of said crease line prior to cutting thereof

80. The three dimensional folded product of any one of claims 68 to 79, wherein a variation of said depth of said at least one cut along said at least one cut is within 15%, within 10%, within 8%, or within 5% of said thickness of said substrate.

81. The three dimensional folded product of any one of claims 68 to 80, wherein a variation of said depth of said at least one cut along said at least one cut is within 15%, within 10%, within 8%, or within 5% of said depth of said at least one cut.

82. The three dimensional folded product of any one of claims 68 to 81, wherein said at least one cut is disposed at a center of a cross section of said crease line.

83. The three dimensional folded product of any one of claims 68 to 82, wherein said at least one cut is disposed at a minimum point of a cross section of said crease line.

84. The three dimensional folded product of any one of claims 68 to 83, wherein a bead of said crease line is visible along an entire length of said fold line.

85. The three dimensional folded product of any one of claims 68 to 83, wherein a bead of said crease line is visible in sections of said crease line including said at least one cut.

86. The three dimensional folded product of any one of claims 68 to 85, wherein said at least one substrate sheet comprises a fibrous substrate sheet.

87. The three dimensional folded product of claim 86, wherein said at least one substrate sheet comprises a cardboard sheet.

88. The three dimensional folded product of claim 86 or claim 87, wherein said at least one substrate sheet comprises a corrugated substrate sheet.

89. The three dimensional folded product of any one of claims 68 to 88, wherein said at least one substrate sheet has a thickness greater than 450 μm, greater than 500 μm, greater than 550 μm, greater than 600 μm, or greater than 650 μm.

90. The three dimensional folded product of claim 86 or claim 87, wherein said fibrous substrate sheet is a laminated fibrous substrate sheet.

91. The three dimensional folded product of claim 90, wherein said laminated fibrous substrate sheet has a thickness less than 350 μm, less than 300 μm, less than 250 μm, or less than 200 μm.
